(19) United States
(12) Patent Application Publication
(10) Pub. No.: US 2007/0262161 A1
(43) Pub. Date: Nov. 15, 2007

(54) Power Saving Apparatus and Method Thereof

(76) Inventor: Philip Davies, Birmingham (GB)

Correspondence Address: LAW OFFICES OF LAI & ASSOCIATES, P.C, SUITE 200, 5800 RANCHESTER, HOUSTON, TX, 77036, US

(21) Appl. No.: 11/552,902

(22) Filed: Oct. 25, 2006

Related U.S. Application Data
(60) Provisional application No. 60/799,020, filed on May 10, 2006.

(51) Int. Cl. G05D 23/00; F25B 49/00

(52) U.S. Cl. 236/13; 62/228.1

(57) ABSTRACT

A power saving apparatus is applied in a temperature regulator. The temperature regulator comprises a compressor. The power saving apparatus is electrically connected to the temperature regulator. The power saving apparatus comprises a sensor, a processing unit and a switching unit. The sensor is for sensing temperatures to generate a sensing signal. The processing unit is connected to the sensor for receiving the sensing signal to generate a switching instruction. The switching unit switches the compressor into an operation status or a silence status based on the switching instruction.

### FIELD OF THE INVENTION

The present invention relates to a power saving apparatus and method thereof, and more particularly to the apparatus that achieves power saving by controlling a compressor and by effectively sensing a room temperature.

### BACKGROUND OF THE INVENTION

Referring to FIG. 1, a schematic diagram illustrates a conventional air conditioning system. The air conditioning system comprises a compressor 11, an evaporator 13, a condenser 14 and an expansion valve 12, wherein refrigerant circulates in the air conditioner. Refrigerant is a easily evaporated liquid and like blood in a human body so as to play a role of absorbing heat in the evaporator 13 and dissipating heat in the condenser 14. Exactly speaking, the air conditioning system is heat-transport equipment that transports the indoor heat to the outdoor. The compressor 11 uses a motor for a power that compresses gaseous refrigerant with low pressures and low temperatures into gaseous refrigerant with high pressures and high temperatures and circulates refrigerant in the air conditioner. The condenser 14 cools the gaseous refrigerant with high pressures and high temperatures to the liquid refrigerant with high pressures and moderate temperatures through cooling mediums (air or water). The indoor heat absorbed by the refrigerant in the evaporator 13 is blown by the cooling mediums and fans to the outdoor through the condenser 14. The expansion valve 12 decompresses the liquid refrigerant with high pressures and moderate temperatures to the liquid refrigerant with low pressures and moderate temperatures. The purpose of decompression is to enable the refrigerant to implement low-temperature evaporation (heat absorption) under low pressures by using the evaporator 13. The evaporator 13 evaporates the liquid refrigerant with low pressures and moderate temperatures to the gaseous refrigerant with low pressures and low temperatures. When indoor air flows through the evaporator 13, the refrigerant is evaporated by absorbing heat generated by the indoor air to reduce the temperatures of the indoor air which flows through the evaporator 13, thereby achieving the goal of cooling down.

The conventional air conditioning system continuously operates based on the refrigeration temperature set by the user. When the air conditioning system senses the setting temperature, the compressor is turned off. The fan mode is then activated. The conventional air conditioning system usually senses once every 3 to 5 minutes. However, the room temperature is sensed after the room temperature is lower than the setting temperature. When the compressor is turned off for a while, air blown from air outlets of the air conditioner is still cool air. The indoor temperatures further drop. An error is generated between the actual indoor temperature and the temperature set by the user. Electric power is also wasted. If the temperature sensing and the compressor can be effectively sensed and controlled, power and energy savings can be achieved.

The inventor of the present invention based on years of experience to conduct extensive researches and experiments invents a power saving apparatus and method thereof, as a method or a basis for achieving the aforementioned object.

### SUMMARY OF THE INVENTION

Accordingly, an object of the present invention is to provide a power saving apparatus and method thereof. More specifically, the apparatus can achieve power saving by controlling a compressor and by effectively sensing a room temperature.

To achieve the foregoing object, the power saving apparatus is applied in a temperature regulator. The temperature regulator comprises a compressor. The power saving apparatus is electrically connected to the temperature regulator. The power saving apparatus comprises a sensor, a processing unit, and a switching unit. The sensor is for sensing temperatures to generate a sensing signal. The processing unit is electrically connected to the sensor for receiving the sensing signal to generate a switching instruction. The switching unit switches the compressor to an operation status or a silence status based on the switching instruction.

The sensor of the power saving apparatus could sense many times every minute to sense the room temperature in real-time to generate a sensing signal that is then transmitted to the processing unit. The processing unit compares the temperature setting set by a user with a sensed temperature of the sensing signal to generate a difference. When the difference is smaller than a predetermined value, the compressor is turned off. Air blown from an air outlet of the temperature regulator still has a temperature regulating function that enables the room temperature to be regulated to the temperature set by the user, thereby achieving power saving.

Other features and advantages of the present invention and variations thereof will become apparent from the following description, drawings, and claims.

### BRIEF DESCRIPTION OF THE DRAWINGS

FIG. 1 is a schematic drawing illustrating a conventional air conditioner;

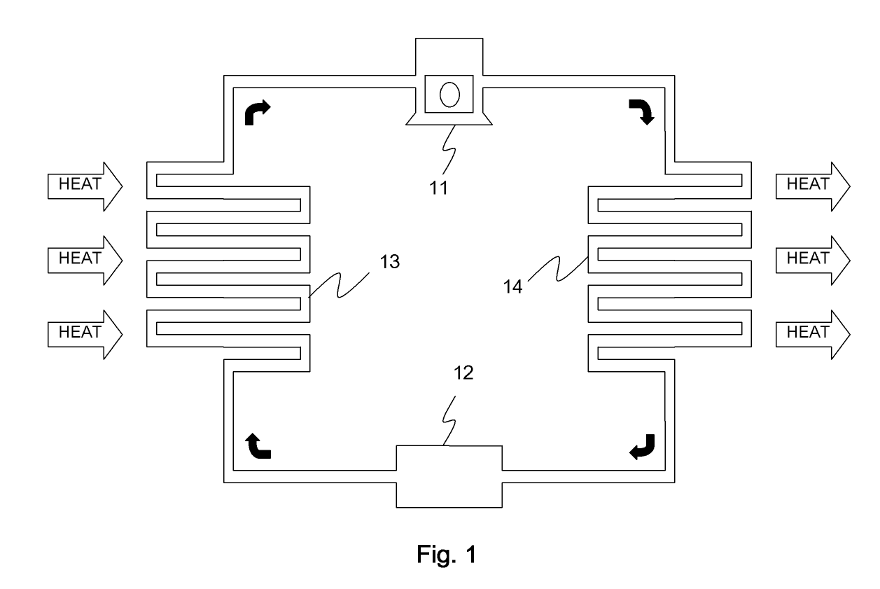

FIG. 2 is a block diagram illustrating a power saving apparatus of the present invention;

FIG. 3 is a block diagram illustrating a power saving apparatus according to a preferred embodiment of the present invention; and

FIG. 4 is a flowchart illustrating a power saving method of the present invention.

### DETAILED DESCRIPTION OF THE PREFERRED EMBODIMENTS

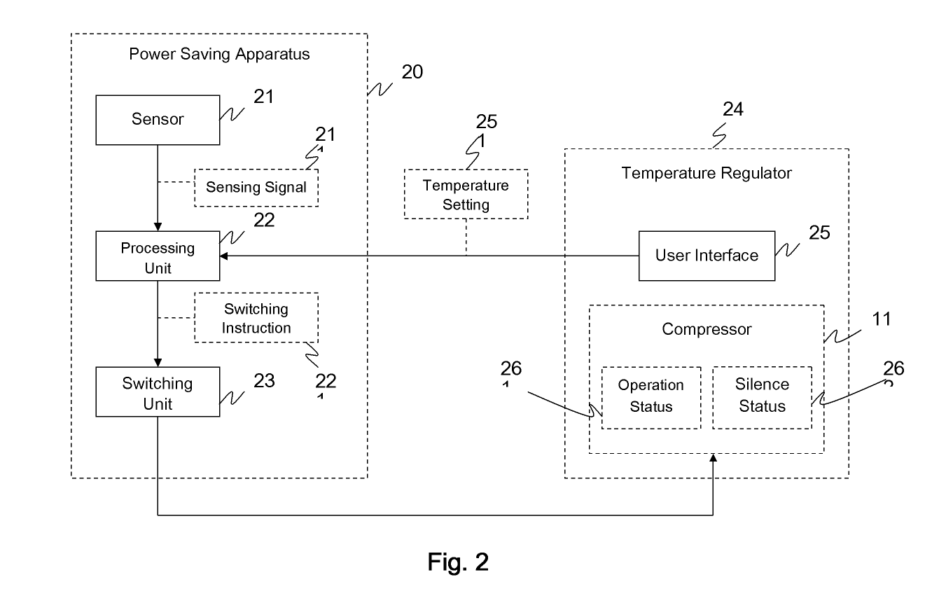

Referring to FIG. 2, a block diagram illustrates a power saving apparatus of the present invention. The power saving apparatus 20 is applied in a temperature regulator 24. The temperature regulator 24 comprises a compressor 11. The power saving apparatus 20 is electrically connected to the temperature regulator 24. The power saving apparatus 20 comprises a sensor 21, a processing unit 22 and a switching unit 23. The sensor 21 is for sensing temperatures to generate a sensing signal 211. The processing unit 22 is electrically connected to the sensor 21 for receiving the sensing signal 211 to generate a switching instruction 221. The switching unit 23 switches the compressor 11 to an operation status 261 or a silence status 262 based on the switching instruction 221.

The temperature regulator comprises a user interface (UI) for providing a user to input a temperature setting. The processing unit generates the switching instruction based on the temperature setting and the sensing signal. The processing unit generates the switching instruction for a silence status when a difference generated between the temperature setting and the sensed temperature of the sensing signal is smaller than a predetermined value. The processing also generates the switching instruction for an operation status when a difference generated between the temperature setting and the sensed temperature of the sensing signal is greater than the predetermined value. The temperature regulator is an air-conditioner or a heater. The processing unit is a microprocessor.

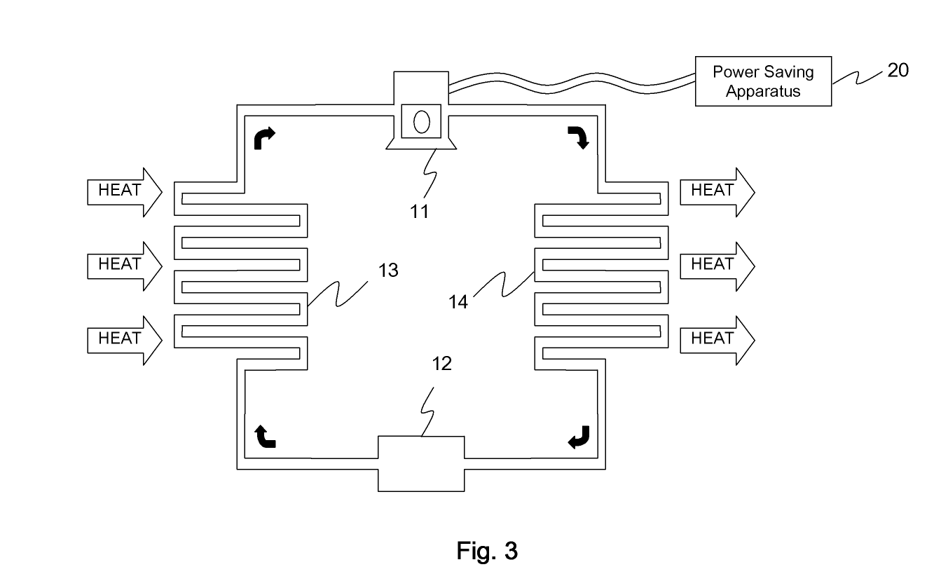

Referring to FIG. 3, a schematic diagram illustrates a power saving apparatus according to a preferred embodiment of the present invention. The power saving apparatus 20 is connected to the compressor 11 of the air conditioner. When air-conditioning function of the temperature regulator is activated, the power saving apparatus 20 continuously senses a room temperature. When a difference generated between the dropped temperature and the temperature set by the user is smaller than a predetermined value, the power saving apparatus 20 turns off the compressor 11. The evaporator 13 still has a portion of liquid refrigerant that continuously absorbs heat in air. Hence, air blown from the air outlet is cool air that can lower the temperature. The room temperature is therefore decreased to the temperature set by the user.

When heating function of the temperature regulator is activated, the power saving apparatus 20 continuously senses the room temperature. When a temperature difference between the increased temperature and the temperature set by the user is smaller than a predetermined value, the power saving apparatus 20 turns off the compressor 11. The evaporator 14 still has gaseous refrigerant with high temperatures and high pressures that continuously dissipates heat energy to air. Air blown from the air outlet of the temperature regulator is hot air that can increase temperatures. The room temperature is therefore increased to the temperature set by the user.

Because the power saving apparatus 20 turns off the compressor 11 before the room temperature tends toward the temperature set by the user, thereby achieving power saving. In the conventional air conditioner, without the power saving apparatus 20, the compressor 11 is turned off until the compressor 11 continuously operates to the temperature set by the user. The compressor 11 still transports cool air or hot air after turning off. It does not only generate a greater error between the room temperature and the temperature set by the user and uncomfortable experiences on the user, but also wastes power.

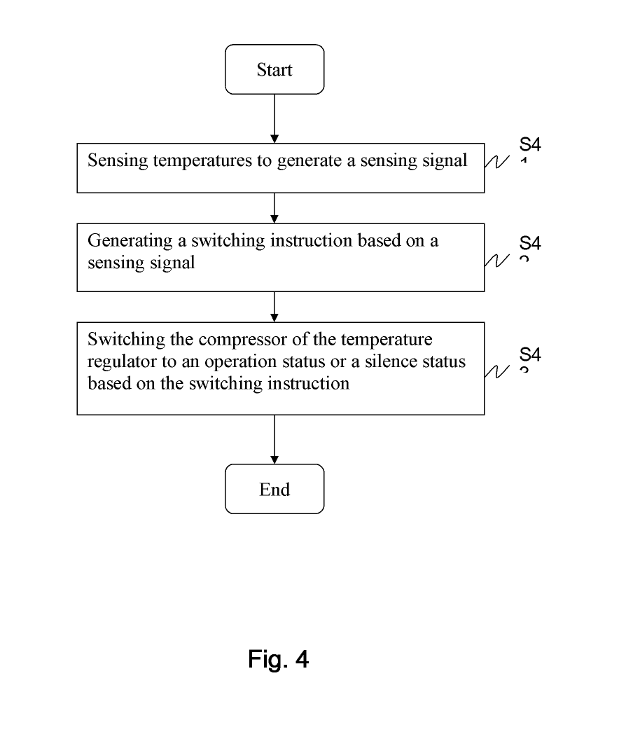

Referring to FIG. 4, a flowchart illustrates a power saving method of the present invention. The power saving method is applied in a power saving apparatus. The power saving apparatus is electrically connected to a temperature regulator. The temperature regulator comprises a compressor. The power saving method comprises the following steps:

Step S41: sensing temperatures to generate a sensing signal;

Step S42: generating a switching instruction based on a sensing signal; and

Step S43: switching the compressor of the temperature regulator to an operation status or a silence status based on the switching instruction.

The temperature regulator comprises a user interface (UI) that provides the user to input a temperature setting. The power saving apparatus generates the switching instruction based on the temperature setting and the sensing signal. The power saving apparatus generates the switching instruction for the silence status when a temperature difference between the temperature setting and the sensed temperature of the sensing signal is smaller than a predetermined value. The power saving apparatus also generates the switching signal for the operation status when a temperature difference between the temperature setting and the sensed temperature of the sensing signal is greater than a predetermined value. The temperature regulator is air-conditioner or a heater.

Although the features and advantages of the embodiments according to the preferred invention are disclosed, it is not limited to the embodiments described above, but encompasses any and all modifications and changes within the spirit and scope of the following claims.

What is claimed is:

1. A power saving apparatus, applicable for a temperature regulator, said temperature regulator comprising a compressor, said power saving apparatus electrically being connected to said temperature regulator, and said power saving apparatus comprising:
a sensor for sensing temperatures to generate a sensing signal;
a processing unit electrically connected to said sensor for receiving said sensing signal to generate a switching instruction; and
a switching unit for switching said compressor to an operation status or a silence status based on said switching instruction.

2. The power saving apparatus of claim 1, wherein said temperature regulator comprises a user interface (UI) for providing a user to input a temperature setting, and said processing unit generates said switching instruction based on said temperature setting or said sensing signal.

3. The power saving apparatus of claim 2, wherein said processing unit generates said switching instruction for said silence status when a difference generated between said temperature setting and a sensed temperature of said sensing signal is smaller than a predetermined value, and said switching instruction for said operation status is generated when a different generated between said temperature setting and a sensed temperature of said sensing signal is greater than said predetermined value.

4. The power saving apparatus of claim 1, wherein said temperature regulator is an air-conditioner or a heater.

5. The power saving apparatus of claim 1, wherein said processing unit is a microprocessor.

6. A power saving method, applicable for a power saving apparatus, said power saving apparatus being electrically connected to a temperature regulator, said temperature comprising a compressor, and said power saving method comprising:
sensing temperatures to generate a sensing signal;
generating a switching instruction based on said sensing signal; and
switching said compressor of said temperature regulator to an operation status or a silence status based on said switching instruction.

7. The power saving method of claim 6, wherein said temperature regulator comprises a user interface (UI) for providing a user to input a temperature setting, and said processing unit generates said switching instruction based on said temperature setting or said sensing signal.

8. The power saving method of claim 7, wherein said power saving apparatus generates said switching instruction for said silence status when a difference generated between said temperature setting and a sensed temperature of said sensing signal is smaller than a predetermined value, and said switching instruction for said operation status is generated when a different generated between said temperature setting and a sensed temperature of said sensing signal is greater than said predetermined value.

9. The power saving method of claim 6, wherein said temperature regulator is an air-conditioner or a heater.

10. The power saving method of claim 6, further comprising the step of providing a microprocessor for receiving said sensing signal to generate said switching instruction.
